(19) United States
(12) Patent Application Publication
(10) Pub. No.: US 2003/0079099 A1
(43) Pub. Date: Apr. 24, 2003

(54) Nonvolatile semiconductor memory device with password unlock function

(75) Inventor: Junya Kawamata, Kawasaki (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Fujitsu Limited

(21) Appl. No.: 10/199,071

(22) Filed: Jul. 22, 2002

(30) Foreign Application Priority Data
Oct. 19, 2001 (JP) 2001-322813

(51) Int. Cl. G06F 12/14

(52) U.S. Cl. 711/164

(57) ABSTRACT

A nonvolatile semiconductor memory device includes a memory cell array including nonvolatile memory cells, a verify-purpose sense amplifier which checks data of the memory cell array at a time of a program operation, a data input buffer which receives data from an exterior of the device, and a match/mismatch check circuit which checks whether a password entered from the exterior of the device into the data input buffer matches a password that is retrieved from the memory cell array and checked by the verify-purpose sense amplifier.

### BACKGROUND OF THE INVENTION

1. Field of the Invention

The present invention generally relates to nonvolatile semiconductor memory devices, and particularly relates to a nonvolatile semiconductor memory device provided with a data protection function based on use of a password.

2. Description of the Related Art

Some nonvolatile semiconductor memory devices of today are provided with a protection function, which prohibits rewriting of memory contents on a sector-specific or block-specific basis where the sector refers to a unit by which memory is erased at a time, and the block refers to a plurality of such units. Information about memory areas (sectors or blocks) that are protected from rewriting is stored in a nonvolatile memory as a protection status. A control circuit (state machine) of the nonvolatile semiconductor memory device refers to this information so as to prohibit the rewriting of protected areas.

A password mode is provided for the purpose of preventing the protection status from being changed through unauthorized access. In the password mode, the nonvolatile memory that stores the protection status is locked so as not to be rewritten, thereby making it sure that the protection status cannot be changed in the default operation. This lock is disengaged if a password entered from the exterior matches the password stored in the nonvolatile memory, thereby making it possible to change the protection status. This unlocking operation is called a password unlock.

The password unlock operation is an operation of such a type as to continue to be performed automatically within the chip in response to a relevant command until the unlock state is achieved. Such operation that continues to be automatically performed within the chip is referred to as an embedded algorithm. A program/erase operation that is performed for nonvolatile memory elements is also based on an embedded algorithm.

In nonvolatile semiconductor memory devices of a dual operation type, a read operation can be performed on a given bank while a program/erase operation is performed on another bank. A password unlock operation that continues to be performed automatically inside the chip as an embedded algorithm also needs to be allowed to run concurrently with a read operation, in the same manner as the program/erase operation running concurrently with a read operation. Because of this requirement, the password unlock operation cannot use those paths and circuitry which are used by a read operation despite the fact that the password unlock operation is basically a read operation that retrieves password data.

It is possible to add new circuitry dedicated for use by the password unlock operation to an existing configuration of a nonvolatile semiconductor memory device, thereby providing the function of password unlocking for the nonvolatile semiconductor memory device. Such addition, however, is not desirable in that it leads to increases in circuit size and complexity of control operations.

Accordingly, there is a need for a nonvolatile semiconductor memory device that performs a password unlock operation by staying within an existing circuitry configuration while avoiding use of paths and circuitry that are used by read operations.

### SUMMARY OF THE INVENTION

It is a general object of the present invention to provide a nonvolatile semiconductor memory device that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a nonvolatile semiconductor memory device particularly pointed out in the specification in such full, clear, concise, and exact terms as to enable a person having ordinary skill in the art to practice the invention.

To achieve these and other advantages and in accordance with the purpose of the invention, as embodied and broadly described herein, a nonvolatile semiconductor memory device according to the present invention includes a memory cell array including nonvolatile memory cells, a verify-purpose sense amplifier which checks data of the memory cell array at a time of a program operation, a data input buffer which receives data from an exterior of the device, and a match/mismatch check circuit which checks whether a password entered from the exterior of the device into the data input buffer matches a password that is retrieved from the memory cell array and checked by the verify-purpose sense amplifier.

In the nonvolatile semiconductor memory device as described above, the verify-purpose sense amplifier for use in a program operation is made shared use of in the password unlock operation so as to check whether the entered password matches the retrieved password. A nonvolatile semiconductor memory device is thus provided that performs a password unlock operation by utilizing an existing configuration while avoiding use of paths and circuitry provided for read operations.

According to another aspect of the present invention, a method of controlling a nonvolatile semiconductor memory device includes the steps of retrieving data from a memory cell, checking the data retrieved from the memory cell to determine whether the data is 0 or 1, checking a mode, after the checking of the data, to determine whether a program mode is engaged or a password unlock mode is engaged, performing a program operation according to a result of the checking of the data by treating the checking of the data as a verify check if the checking of a mode finds that the program mode is engaged, checking a password to determine whether the password entered from an exterior of the device matches the result of the checking of the data if the checking of a mode finds that the password unlock mode is engaged, and performing a password unlock operation in response to a match determination made by the checking of a password.

In the method of controlling a nonvolatile semiconductor memory device as described above, the procedure of data check operation for the verify purpose performed at the time of program operation is utilized for the data check operation of a password unlock operation so as to check whether the entered password matches a retrieved password. A method of controlling a nonvolatile semiconductor memory device is thus provided that performs a password unlock operation by utilizing an existing configuration while avoiding use of paths and circuitry provided for read operations.

Other objects and further features of the present invention will be apparent from the following detailed description when read in conjunction with the accompanying drawings.

### BRIEF DESCRIPTION OF THE DRAWINGS

FIG. 1 is a block diagram showing a schematic configuration of a nonvolatile semiconductor memory device according to the present invention;

FIG. 2 is a flowchart showing a password unlock operation according to the present invention;

FIG. 3 is a timing chart showing entry of a password unlock command followed by entry of password data portions;

FIG. 4 is a circuit diagram showing an example of a circuit configuration of a password-unlock-register-&-complete-match-check circuit;

FIG. 5 is a circuit diagram showing another example of a circuit configuration of the password-unlock-register-&-complete-match-check circuit;

FIG. 6 is a timing chart showing the operation of the password-unlock-register-&-complete-match-check circuit shown in FIG. 5 with reference to the case of complete matches;

FIG. 7 is a timing chart showing the operation of the password-unlock-register-&-complete-match-check circuit with reference to the case of a mismatch;

FIG. 8 is a circuit diagram showing an example of the configuration of a lock/unlock setting circuit;

FIG. 9 is a circuit diagram showing an example of a circuit configuration of a verify-purpose sense amplifier;

FIG. 10 is a circuit diagram showing an example of the circuit configuration of a verify-purpose reference circuit; and

FIG. 11 is a block diagram showing another example of a nonvolatile semiconductor memory device to which the password unlock procedure and relevant configuration of the present invention are applied.

### DESCRIPTION OF THE PREFERRED EMBODIMENTS

In the following, embodiments of the present invention will be described with reference to the accompanying drawings.

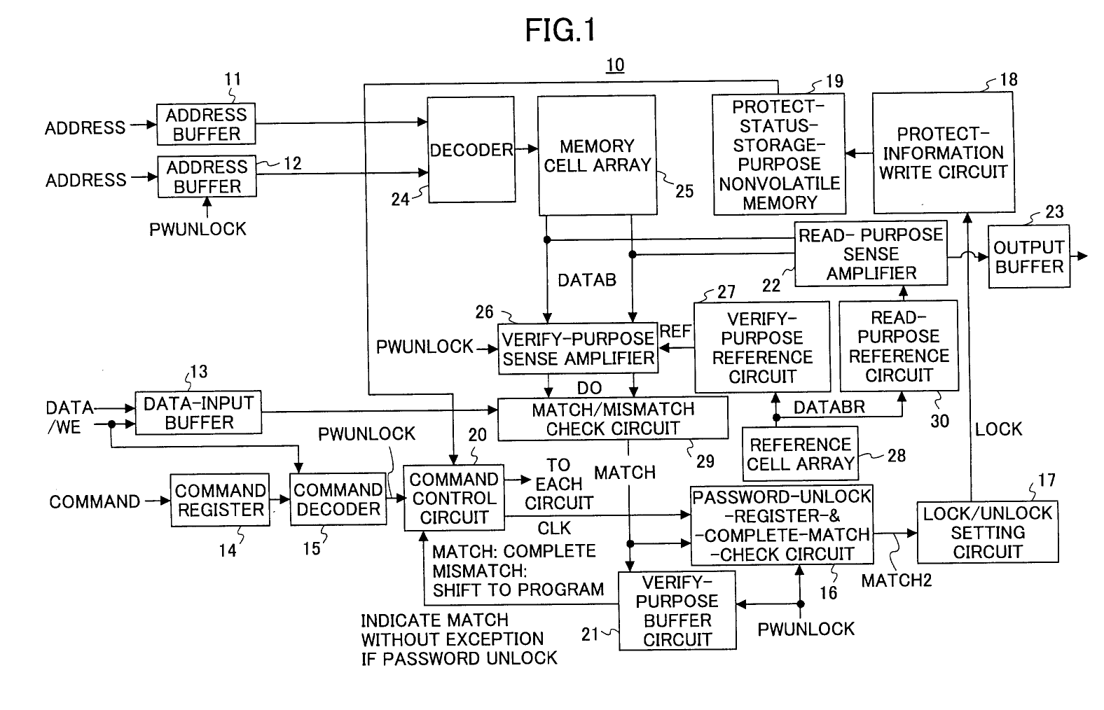

FIG. 1 is a block diagram showing a schematic configuration of a nonvolatile semiconductor memory device according to the present invention.

A nonvolatile semiconductor memory device 10 of FIG. 1 includes address buffers 11 and 12, a data-input buffer 13, a command register 14, a command decoder 15, a password-unlock-register-&-complete-match-check circuit 16, a lock/unlock setting circuit 17, a protect-information write circuit 18, a protect-status-storage-purpose nonvolatile memory 19, a command control circuit 20, a verify-purpose buffer circuit 21, a read-purpose sense amplifier 22, an output buffer 23, a decoder 24, a memory cell array 25, a verify-purpose sense amplifier 26, a verify-purpose reference circuit 27, a reference cell array 28, a match/mismatch check circuit 29, a read-purpose reference circuit 30.

The command register 14 receives command signals and control signals from an exterior of the device, and stores a command therein. The command stored in the command register 14 is decoded by the command decoder 15, and the decoded command is supplied to the command control circuit 20. The command control circuit 20 functions as a state machine to control internal circuitry of the nonvolatile semiconductor memory device 10 based on the decoded command supplied thereto.

The address buffers 11 and 12 receive X address signals and Y address signals, respectively, supplied from the exterior of the device, and provide these address signals to the decoder 24. The decoder 24 decodes the supplied X address signals, and selects nonvolatile memory cells at the indicated X address in the memory cell array 25 based on the decoded results. Further, the decoder 24 decodes the supplied Y address signals, and selects nonvolatile memory cells at the indicated Y address in the memory cell array 25 based on the decoded results. In the case of a program or erase operation, the bit lines corresponding to the indicated Y address are selectively coupled to the verify-purpose sense amplifier 26. In the case of a read operation, the bit lines corresponding to the indicated Y address are coupled to the read-purpose sense amplifier 22.

The memory cell array 25 includes an array of memory cells, word lines, bit lines, and so on, and stores information in each memory cell. At the time of data read operation, data retrieved from a selected memory cell of the memory cell array 25 is supplied to the read-purpose sense amplifier 22. The read-purpose sense amplifier 22 determines whether the retrieved data is 0 or 1. The check determination is output from the output buffer 23 as read data. At the time of program or erase operation, a predetermined program potential or erase potential is applied to the memory cell array 25 under the control of the command control circuit 20, so that the word lines and bit lines of the memory cell array 25 are set to proper potentials suitable for respective operations. In this manner, injection or ejection of electric charge is carried out with respect to memory cells.

In program operations and erase operations, the verify-purpose sense amplifier 26 compares the level of data supplied from the memory cell array 25 with a reference level supplied from the verify-purpose reference circuit 27, thereby making a determination as to whether the data is 0 or 1. Until the check determination indicates a desired data value, a program operation or an erase operation will be repeated so as to insure sufficient electric charge injection or ejection.

The verify-purpose reference circuit 27 is connected to the reference cell array 28 that includes reference memory cells. The verify-purpose reference circuit 27 operates under the control of the command control circuit 20, and generates a reference level REF based on a potential supplied from a reference memory cell of the reference cell array 28. The reference level REF is supplied to the verify-purpose sense amplifier 26 for use at the time of data checks. The read-purpose reference circuit 30 generates a reference level based on a potential supplied from a reference memory cell of the reference cell array 28, and supplies the generated reference level to the read-purpose sense amplifier 22 for use in data checks at the time of data reading.

In the present invention, a password matching operation at the time of password unlocking is performed by using a set of verify-related circuits that are sued for program and erase operations.

In detail, when a password unlock command is entered from the exterior of the device, the command decoder 15 generates a password unlock signal PWUNLOCK. The password unlock signal PWUNLOCK is supplied to the password-unlock-register-&-complete-match-check circuit 16, the command control circuit 20, the verify-purpose buffer circuit 21, and the verify-purpose sense amplifier 26. In response to the password unlock signal PWUNLOCK, the command control circuit 20 controls the operation of circuits relevant to a password unlock operation.

Under the control of the command control circuit 20, a password is retrieved from the memory cell array 25, and is then supplied to the verify-purpose sense amplifier 26. The verify-purpose sense amplifier 26 checks data levels of the retrieved password, and supplies the checked data levels to the match/mismatch check circuit 29. The password supplied from the exterior of the device is provided to the match/mismatch check circuit 29 via the data-input buffer 13. The match/mismatch check circuit 29 compares the password supplied from the verify-purpose sense amplifier 26 with the password entered through the data-input buffer 13, thereby checking whether these two passwords match. The match/mismatch check circuit 29 supplies a match check signal MATCH indicative of a password match/mismatch to the password-unlock-register-&-complete-match-check circuit 16 and the verify-purpose buffer circuit 21.

The password-unlock-register-&-complete-match-check circuit 16 is configured so as to output a LOW signal in a default state. When the password unlock signal PWUNLOCK is entered to indicate a password unlock mode, the password-unlock-register-&-complete-match-check circuit 16 latches the match check signal MATCH. In the password matching of the present invention, consecutive matching operations are performed with respect to respective portions of the password data, as will be described later in detail. The password-unlock-register-&-complete-match-check circuit 16 asserts a complete-match signal MATCH2 to the lock/unlock setting circuit 17 if all the match check signals MATCH that are consecutively generated for respective portions of the password indicate a match.

In response to the asserted state of the complete-match signal MATCH2, the lock/unlock setting circuit 17 puts an end to a lock state by disabling the lock signal LOCK. When the lock signal LOCK is disabled, the protect-information write circuit 18 allows a write operation to be performed with respect to the protect-status-storage-purpose nonvolatile memory 19.

The protect-status-storage-purpose nonvolatile memory 19 is a set of memory cells that store a protect status where the protect status is the information about a sector or a block of the memory cell array 25 in which no writing is permitted. By referring to the protect status stored in the protect-status-storage-purpose nonvolatile memory 19, the command control circuit 20 controls write operations regarding the memory cell array 25. Once the password is unlocked, the protect-information write circuit 18 permits rewriting of the protect-status-storage-purpose nonvolatile memory 19, thereby making it possible to change the write protection status of the memory cell array 25.

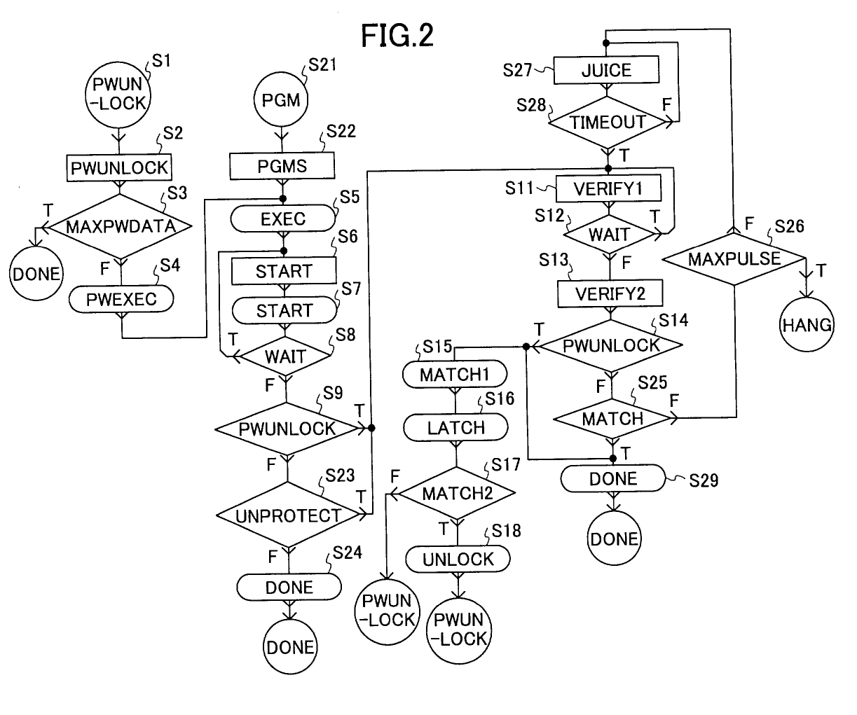

FIG. 2 is a flowchart showing a password unlock operation according to the present invention. The password unlock operation of the present invention is mainly performed by the command control circuit 20 based on the utilization of an existing program operation of the nonvolatile semiconductor memory device and the shared use of part of a program operation procedure.

At step S1, the start of a password unlock mode is declared in response to a password unlock command. At step S2, the operation state changes into the password unlock mode.

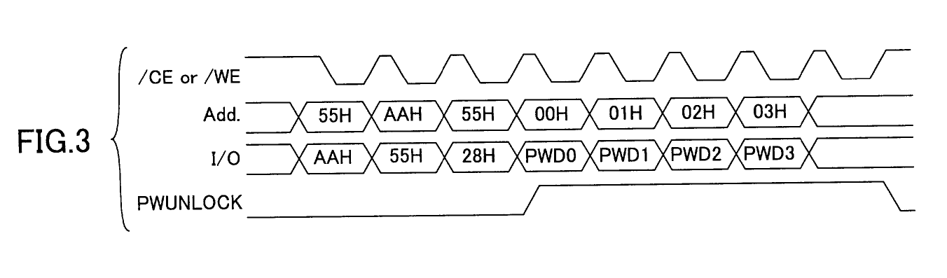

At step S3, a check is made as to whether the current data input is a data input entered after the last data of a password. It should be noted that the password data does not necessarily have the same number of bits as input/output data. Even when the input/output data is 16 bits, for example, the password may possibly be comprised of 64 bits. In such a case, the entire password data is entered by consecutively entering respective 16-bit data portions through the input/output data pins, and password matching is carried out by successively matching the 16-bit portions with respective portions of the password stored in memory. If the input/output data is 32-bit data, and a password is comprised of 64 bits, for example, two successive matching operations are performed with respect to respective 32-bit portions. In such a case, it is desirable to complete a series of matching operations without exiting from the password unlock mode once the password unlock mode is engaged. In the present invention, therefore, as shown in FIG. 3, entry of a password unlock command (Add: 55H & I/O: 28H) is followed by consecutive entry of a series of 16-bit data portions PWD0 through PWD3 of the password, together with consecutive entry of password addresses 00H through 03H. Here, address data and input data preceding the password unlock command (Add: 55H & I/O: 28H) serve to signal that the following input is a command input. After the last data of the password (e.g., the fourth password data) is entered, further entry of a data item is regarded as a reset instruction, resulting in exiting from the password unlock mode.

At step S3, the password unlock mode is brought to an end if the current data input is regarded as a data input following the last data item of the password. Otherwise, the procedure goes to step S4, at which an embedded algorithm for password unlocking is started. At step S5, then, an embedded algorithm for program operation is started.

It should be noted that, if a routine program command is to be performed, the start of a program mode is declared at step S21 in response to a program command, and the operation state is turned into a program mode at step S22. At the step S5, then, the embedded algorithm for program operation is started.

Regardless of whether the operation mode is a password unlock mode or a program mode, at step S6, the operation state of the state machine (command control circuit 20) turns into a program-operation start state, and the program operation starts at step S7. At step S8, a check is made as to whether a predetermined time period has passed. If it has not passed, the procedure goes back to the step S6. If the predetermined time period has passed, the procedure goes to step S9, at which a check is made as to whether the password unlock mode is engaged. If the password unlock mode is engaged, the procedure goes to step S11. If the password unlock mode is not engaged (i.e., if the program mode is engaged), the procedure proceed to step S23, at which a check is made as to whether a memory area to be programmed is protected or not protected. If the memory area to be programmed is protected, the procedure goes to step S24, at which the embedded program is brought to an end, thereby finishing the program operation. If the memory area to be programmed is not protected, the procedure proceeds to step S11.

Regardless of whether the operation mode is a password unlock mode or a program mode, at the step S11, a verify operation is performed. At step S12, a check is made as to whether preparation for verify operation is completed. If it is not yet completed, the procedure goes back to the step S11. If preparation for verify operation is completed, data is read from memory at step S13. This data is password data retrieved from a password area if the operation mode is a password unlock mode. If the operation mode is a program mode, this data is retrieved from a memory area subjected to program operation.

At step S14, a check is made as to whether the password unlock mode is engaged. If the password unlock mode is engaged, the procedure proceeds to step S15, and, also, the embedded algorithm currently underway is brought to an end. Namely, the verify-purpose buffer circuit 21 of FIG. 1 puts an end to the embedded program performed by the command control circuit 20 in the password unlock mode regardless of whether the match check signal MATCH of the match/mismatch check circuit 29 indicates a match or a mismatch.

At step S15, the match/mismatch check circuit 29 checks whether the retrieved password data matches the entered password data. At step S16, password-unlock-register-&-complete-match-check circuit 16 stores the check determination in a latch. At step S17, the password-unlock-register-&-complete-match-check circuit 16 checks based on the latch data whether each portion of the password matches. If it matches, the lock is disengaged, and the procedure goes back to step S1 where the entry of next data input is waited for. Thereafter, at step S3, the password unlock mode comes to an end in response to a data input following the last data item of the password. Even in the case where the step S17 finds that all the password portions do not match, the procedure goes back to the step S1 where the entry of next data input is waited for. After entry of the last password data, at step S3, the password unlock mode is brought to an end without unlocking because the password does not match. If the last password data is not yet entered, the procedure goes to the step S4, at which the next password data is processed.

If the step S14 finds that the password unlock mode is not engaged, i.e., the program mode is engaged, at step S25, a check is made as to whether the retrieved data matches the program data. If it does not match, a check is made at step S26 as to whether a predetermined number of program operations have been carried out. If they have, the procedure comes to a halt with error. If the predetermined number of program operations have not been carried out, a program operation (charge injection) is performed at step S27. If step S28 finds that a predetermined time period has passed, the procedure goes to the step S11.

If the retrieved data matches the program data at the step S25, the embedded program for the program operation is brought to an end. Namely, the verify-purpose buffer circuit 21 of FIG. 1 puts an end to the embedded program performed by the command control circuit 20 in the program mode if the match check signal MATCH of the match/mismatch check circuit 29 indicates a match.

As described above, the password unlock operation of the present invention makes shared use of the embedded algorithm of the program operation, thereby achieving an effective password unlock operation based on the utilization of an existing control procedure and verify circuitry.

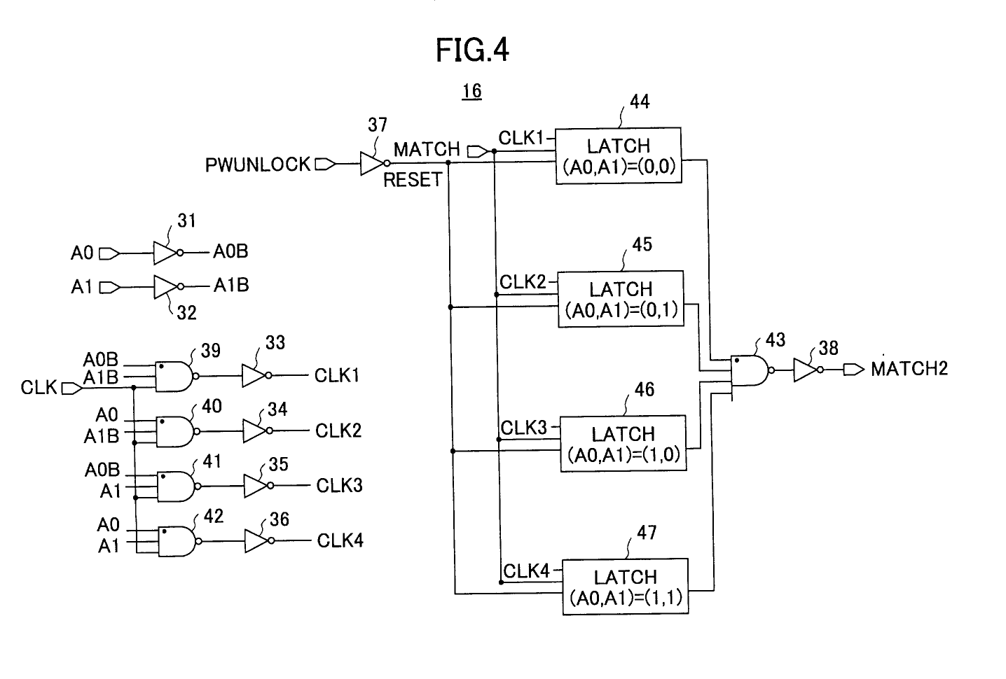

FIG. 4 is a circuit diagram showing an example of a circuit configuration of the password-unlock-register-&-complete-match-check circuit 16.

The password-unlock-register-&-complete-match-check circuit 16 of FIG. 4 includes inverters 31 through 38, NAND circuits 39 through 43, and latch circuits 44 through 47. The inverters 31 and 32 receive as their respective inputs the least significant address bits A0 and A1 that are “00”, “01”, “10”, and “11” corresponding to 00H, 01H, 02H, and 03H entered as shown in FIG. 3, and generate respective inverted signals. The address bits A0 and A1 together with their inverted signals A0B and A1B are supplied to the NAND circuits 39 through 42, which then generate clock signals CLK1 through CLK4 that are each comprised of every fourth clock pulse of the clock signal CLK with varying phase positions. The clock signals CLK1 through CLK4 turn to HIGH at the timing corresponding to addresses 00H, 01H, 02H, and 03H, respectively. The latch circuits 44 through 47 latch the match check signal MATCH in synchronization with the respective clock signals CLK1 through CLK4, corresponding to respective portions of password data. If all the portions of password data match, the match check signals MATCH stored in the latch circuits 44 through 47 all become HIGH, so that the complete-match signal MATCH2 produced through AND logic is set to HIGH.

If the password unlock mode is not engaged, the password unlock signal PWUNLOCK stays LOW, thereby resetting the latch circuits 44 through 47. In this case, the complete-match signal MATCH2 is LOW.

In the configuration of FIG. 4, the order of password data items does not matter, and the four items may be entered in any order preferred.

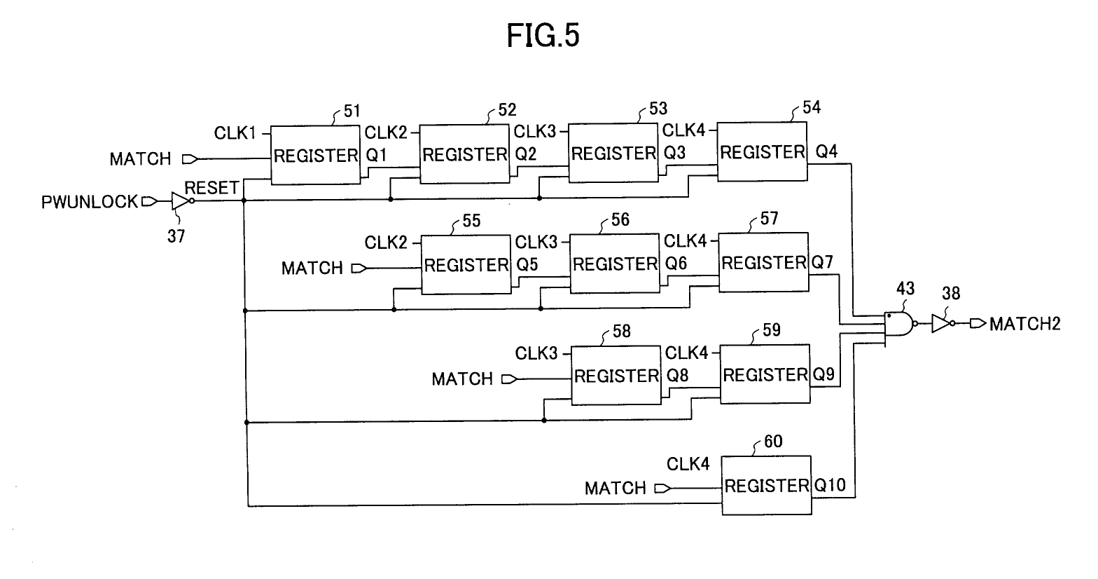

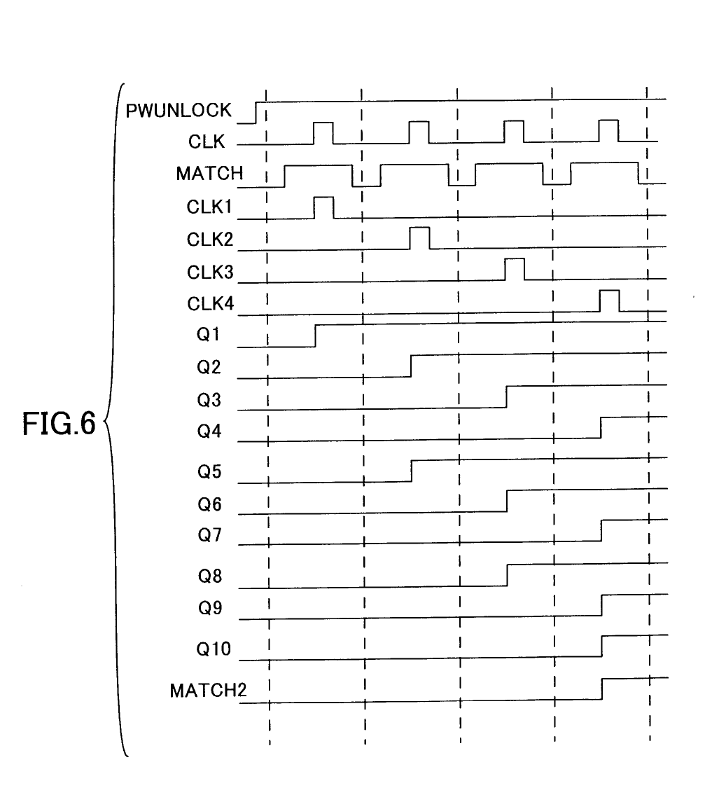

FIG. 5 is a circuit diagram showing another example of a circuit configuration of the password-unlock-register-&-complete-match-check circuit 16. The configuration shown in FIG. 5 is directed to a case in which the order of password data items is significant, and the four items have to be entered in a predetermined order. In FIG. 5, the configuration for generating the clock signals CLK1 through CLK4 is the same as that shown in FIG. 4, and is omitted. FIG. 6 is a timing chart showing the operation of the password-unlock-register-&-complete-match-check circuit 16 shown in FIG. 5 with reference to the case of complete matches.

As shown in FIG. 5 and FIG. 6, the registers 51 through 54 successively latch and shift a match check signal MATCH in synchronization with the clock signals CLK1 through CLK4 where the match check signal MATCH is one that is entered first. The outputs of the registers 51 through 54 are Q1 through Q4, respectively. At the time the clock signal CLK4 is supplied, the register 54 stores therein the match check signal MATCH that is entered first.

By the same token, the registers 55 through 57 successively latch and shift a match check signal MATCH in synchronization with the clock signals CLK2 through CLK4 where the match check signal MATCH is one that is entered second. The outputs of the registers 55 through 57 are Q5 through Q7, respectively. At the time the clock signal CLK4 is supplied, the register 57 stores therein the match check signal MATCH that is entered second.

By the same token, the registers 58 and 59 successively latch and shift a match check signal MATCH in synchronization with the clock signals CLK3 and CLK4 where the match check signal MATCH is one that is entered third. The outputs of the registers 58 and 59 are Q8 and Q9, respectively. At the time the clock signal CLK4 is supplied, the register 59 stores therein the match check signal MATCH that is entered third. Further, the register 60 stores therein a match check signal MATCH that is entered fourth in synchronization with the clock signal CLK4. The output of the register 60 is Q10.

If all the portions of password data match, the match check signals MATCH stored in the latch circuits 54, 57, 59, and 60, i.e., Q4, Q7, Q9, and Q10, are HIGH, so that the complete-match signal MATCH2 produced through AND logic is changed to HIGH.

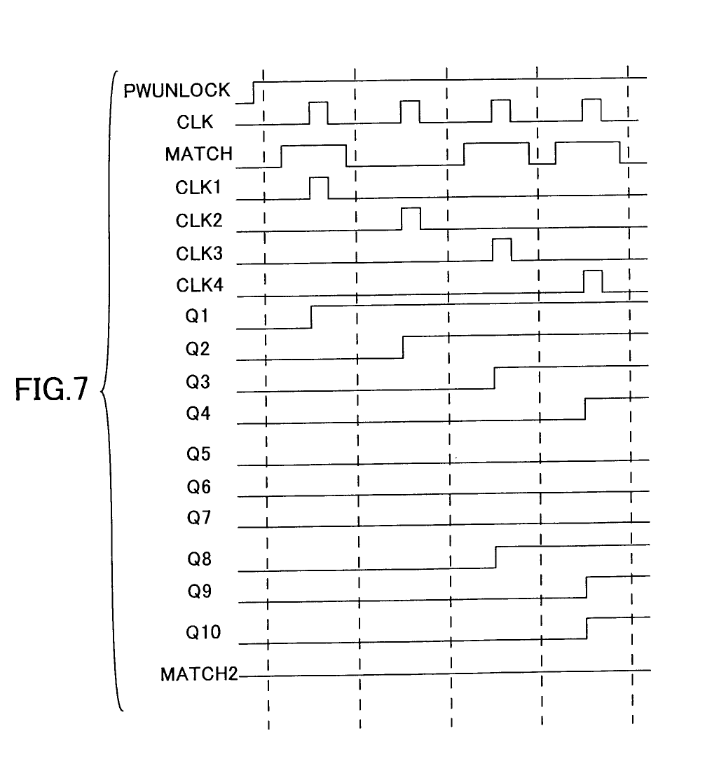

FIG. 7 is a timing chart showing the operation of the password-unlock-register-&-complete-match-check circuit 16 with reference to the case of a mismatch. The example of FIG. 7 shows a case in which the match check signal MATCH entered second is LOW.

As shown in FIG. 7, the match check signal MATCH that is entered second is LOW, so that Q5 through Q7 output from the respective registers 55 through 57 stay LOW. At the timing the clock signal CLK4 is supplied, the output Q7 of the register 57 is LOW, so that the complete-match signal MATCH is set to LOW.

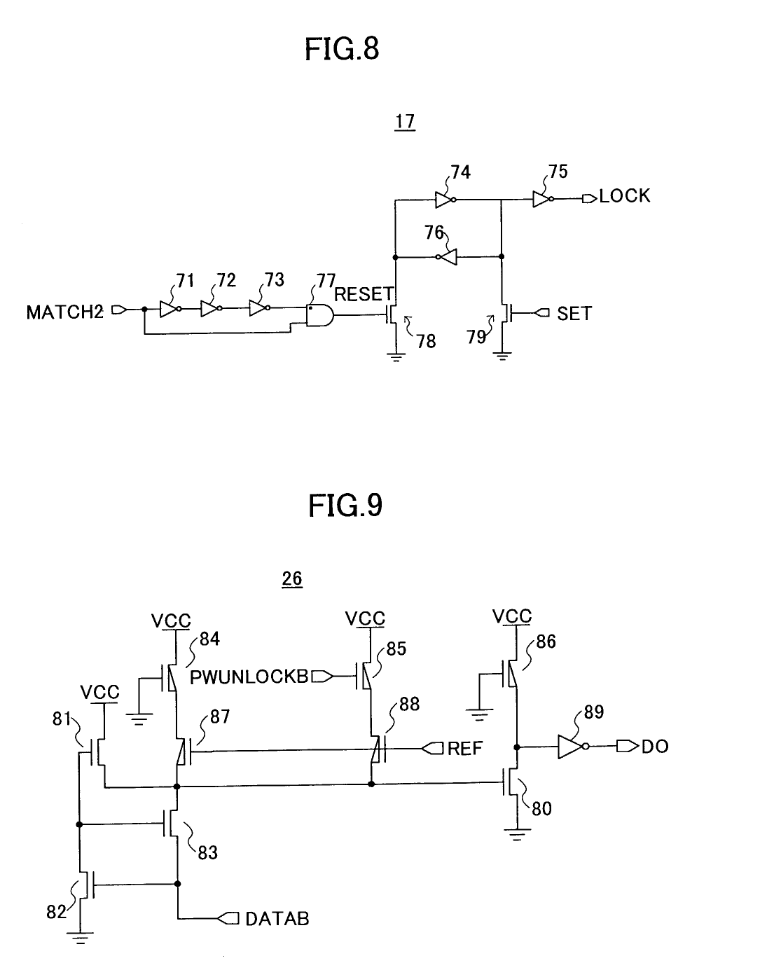

FIG. 8 is a circuit diagram showing an example of the configuration of the lock/unlock setting circuit 17.

The lock/unlock setting circuit 17 of FIG. 8 includes inverters 71 through 76, an AND circuit 77, and NMOS transistors 78 and 79. If the complete-match signal MATCH2 is LOW, the output of the AND circuit 77 is LOW. In this case, a set signal SET is set to HIGH so as to assert the lock signal LOCK (i.e., HIGH) by default, thereby setting the latch comprised of the inverters 74 and 76. IF the complete-match signal MATCH2 becomes HIGH, the output of the AND circuit 77 becomes HIGH for a duration corresponding to the delay of the inverters 71 through 73. This resets the latch comprised of the inverters 74 and 76. As a result, the lock signal LOCK is placed in a disable state (i.e., LOW).

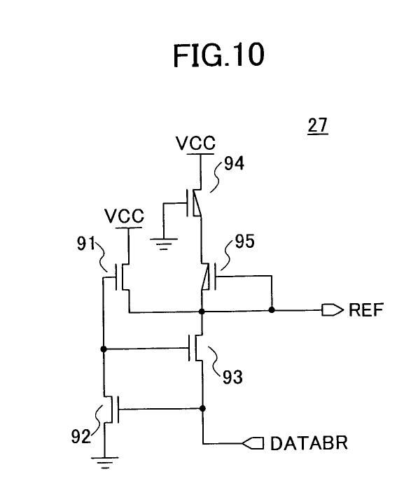

FIG. 9 is a circuit diagram showing an example of a circuit configuration of the verify-purpose sense amplifier 26. FIG. 10 is a circuit diagram showing an example of the circuit configuration of the verify-purpose reference circuit 27.

The verify-purpose sense amplifier 26 of FIG. 9 includes NMOS transistors 80 through 83, PMOS transistors 84 through 88, and an inverter 89. The verify-purpose reference circuit 27 of FIG. 10 includes NMOS transistors 91 through 93 and PMOS transistors 94 and 95.

The verify-purpose reference circuit 27 of FIG. 10 receives a reference data potential DATABR from a reference cell. In response to the reference data potential DATABR, the verify-purpose reference circuit 27 generates a reference potential REF, which is supplied to the verify-purpose sense amplifier 26 of FIG. 9. The verify-purpose sense amplifier 26 also receives a data potential DATAB read from the memory cell array 25. A comparison of the data potential DATAB with the reference data potential DATABR is made via the reference potential REF, and the result of comparison is output from the inverter 89 as the data signal D0.

In the present invention, the PMOS transistors 85 and 88 are provided for the verify-purpose sense amplifier 26 as additional load. In the password unlock mode, an inverse PWUNLOCKB of the password unlock signal PWUNLOCK is supplied to the PMOS transistor 85, thereby making an electric current run from the PMOS transistor 85 to the gate of the NMOS transistor 80. This makes it easier to raise the potential of this gate. In a normal verify operation, the verify threshold is set to a level that is stricter than the read threshold. If the verify-purpose sense amplifier 26 is used as it is, the selected level would be too strict for the password data that is simply read data not subjected to verify operation. In the present invention, therefore, the additional load is provided in the password unlock mode, thereby increasing an electric current that facilitate an increase in the gate potential of the NMOS transistor 80. In this manner, the present invention achieves a proper data check in spite of the use of verify-purpose circuitry by selecting a proper threshold when checking password data that is simply read data.

The above embodiment has been described with reference to a case in which the number of bits in the password data is larger than the number of bits of input/output data. Alternatively, the bit size of the password data may be the same or smaller than the bit size of input/output data. In such a case, the password-unlock-register-&-complete-match-check circuit 16 of FIG. 4 or FIG. 5 may be implemented as a single latch circuit or register that stores therein a single match check signal MATCH and outputs a check result. The circuit configuration that produces four phase-shifted clocks is not necessary in this case, and neither is the AND logic circuit for making a complete-match determination. Alternatively, the password-unlock-register-&-complete-match-check circuit 16 may be removed from the configuration of FIG. 1, and the output of the match/mismatch check circuit 29 may be supplied to the lock/unlock setting circuit 17 through a gate that opens and closes in response to the password unlock signal.

The above embodiment has been described with reference to a case in which the password unlock operation provides a basis for modifying the protection status stored in the protect-status-storage-purpose nonvolatile memory 19. However, the password unlock procedure and relevant configuration of the present invention are applicable to any types of nonvolatile semiconductor memory devices that are equipped with any type of a password function.

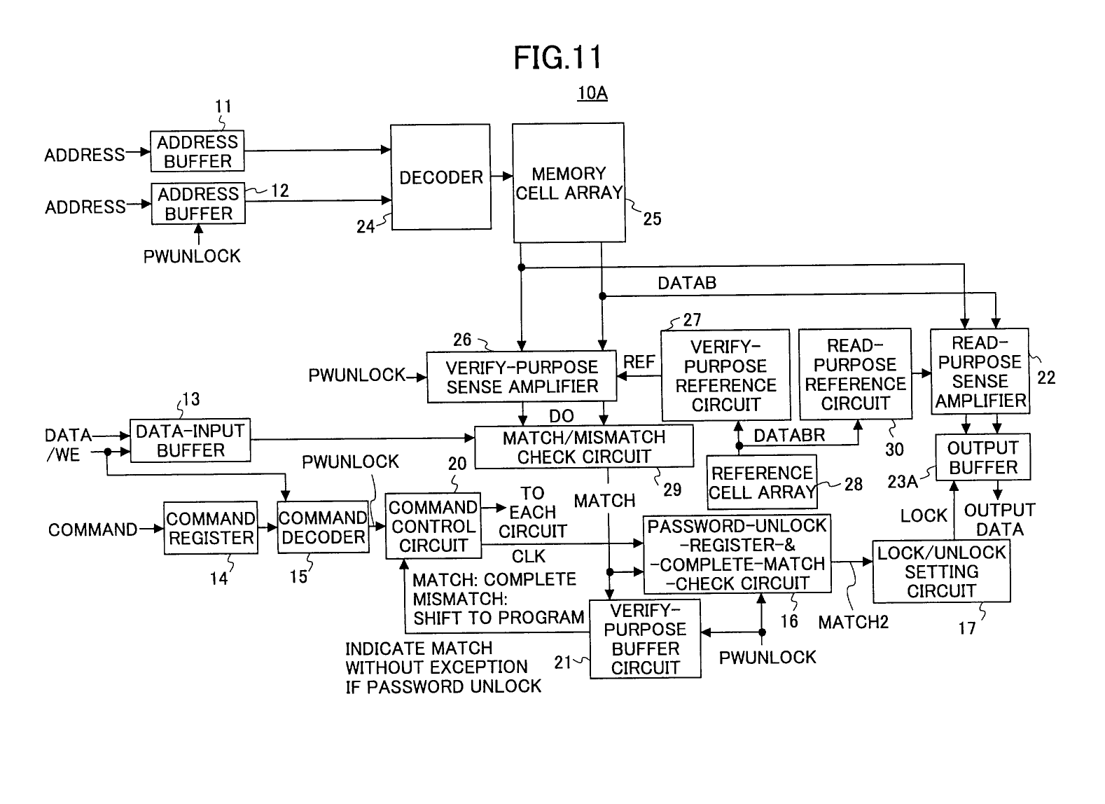

FIG. 11 is a block diagram showing another example of a nonvolatile semiconductor memory device to which the password unlock procedure and relevant configuration of the present invention are applied. In FIG. 11, the same elements as those of FIG. 1 are referred to by the same numerals, and a description thereof will be omitted.

In a nonvolatile semiconductor memory device 10A of FIG. 11, the protect-information write circuit 18 and the protect-status-storage-purpose nonvolatile memory 19 are removed from the nonvolatile semiconductor memory device 10 of FIG. 1, and, further, a output buffer 23A is provided in place of the output buffer 23. The output buffer 23A receives data of a selected memory cell from the memory cell array 25 via the read-purpose sense amplifier 22, and further receives a lock signal LOCK from the lock/unlock setting circuit 17. When the lock signal LOCK is asserted to indicate a lock state, the output buffer 23A does not supply data outputs to the exterior of the device. Namely, the lock state prevents users from reading data from the memory. When a user sets a password unlock mode, and enters a legitimate password, the lock signal LOCK is disabled, and an unlock mode is engaged. Thereafter, the user can read data from the memory cells.

In the configuration of FIG. 11, settings are made such that data of memory cells cannot be read by default for the purpose of insure data security or the like. Entry of a password that disengages the lock permits data reading. In this configuration, the password unlock provision of the present invention can be applied that utilizes the verify-related circuitry and makes shared use of part of the program operation.

Further, the present invention is not limited to these embodiments, but various variations and modifications may be made without departing from the scope of the present invention.

The present application is based on Japanese priority application No. 2001-322813 filed on Oct. 19, 2001, with the Japanese Patent Office, the entire contents of which are hereby incorporated by reference.

What is claimed is:

1. A nonvolatile semiconductor memory device, comprising:
a memory cell array including nonvolatile memory cells;
a verify-purpose sense amplifier which checks data of said memory cell array at a time of a program operation;
a data input buffer which receives data from an exterior of the device; and
a match/mismatch check circuit which checks whether a password entered from the exterior of the device into said data input buffer matches a password that is retrieved from said memory cell array and checked by said verify-purpose sense amplifier.

2. The nonvolatile semiconductor memory device as claimed in claim 1, further comprising:
a nonvolatile memory unit which stores therein a protection status of said memory cell array; and
a protect-information write circuit which prohibits said nonvolatile memory unit from being written in a locked state, wherein said protect-information write circuit is placed in an unlocked state in response to a match determination made by said match/mismatch check circuit finding that the entered password matches the retrieved password, thereby allowing data to be written in said nonvolatile memory unit.

3. The nonvolatile semiconductor memory device as claimed in claim 1, further comprising an output buffer which receives data from said memory cell array, said output buffer prohibiting the data from said memory cell array from being output to an exterior of the device in a locked state, wherein said output buffer is placed in an unlocked state in response to a match determination made by said match/mismatch check circuit finding that the entered password matches the retrieved password, thereby allowing the data from said memory cell array to be output to the exterior of the device.

4. The nonvolatile semiconductor memory device as claimed in claim 1, further comprising a command control circuit which responds to a password unlock command supplied from an exterior of the device by controlling said verify-purpose sense amplifier and said match/mismatch check circuit in such a manner as to check whether the entered password matches the retrieved password.

5. The nonvolatile semiconductor memory device as claimed in claim 1, wherein the entered password is comprised of a plurality of partial data items that are successively entered, and said match/mismatch check circuit successively checks on a partial-data-item-by-partial-data-item basis whether the partial data items of the entered password match respective partial data portions of the retrieved password.

6. The nonvolatile semiconductor memory device as claimed in claim 5, further comprising:
a plurality of latch circuits which latch respective check determinations made by said match/mismatch check circuit on a partial-data-item-by-partial-data-item basis; and
a circuit which produces a signal indicative of a complete match when all the latch circuits store check determinations that indicate a match.

7. The nonvolatile semiconductor memory device as claimed in claim 1, wherein said verify-purpose sense amplifier changes a check standard thereof between a verify operation for checking data of said memory cell array at a time of a program operation and a password read operation for checking data of the retrieved password.

8. The nonvolatile semiconductor memory device as claimed in claim 1, further comprising a read-purpose sense amplifier which is provided separately from said verify-purpose sense amplifier, and checks data of said memory cell array at a time of a read operation.

9. A method of controlling a nonvolatile semiconductor memory device, comprising the steps of:
retrieving data from a memory cell;
checking the data retrieved from the memory cell to determine whether the data is 0 or 1;
checking a mode, after said checking of the data, to determine whether a program mode is engaged or a password unlock mode is engaged;
performing a program operation according to a result of said checking of the data by treating said checking of the data as a verify check if said checking of a mode finds that the program mode is engaged;
checking a password to determine whether the password entered from an exterior of the device matches the result of said checking of the data if said checking of a mode finds that the password unlock mode is engaged; and
performing a password unlock operation in response to a match determination made by said checking of a password.

10. The method as claimed in claim 9, wherein the password unlock operation includes a step of allowing a protection status stored in a nonvolatile memory to be rewritten.
